(19) United States
(12) Patent Application Publication
(10) Pub. No.: US 2009/0293464 A1
(43) Pub. Date: Dec. 3, 2009

(54) Assembly and method of assembly for exhaust treatment

(75) Inventors: Gregory J. Kaufmann, Metamora, IL (US); Alexei Peter Yelistratov, Dunlap, IL (US); Stanley Lester Davis, II, St. Paul, MN (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 12/155,199

(22) Filed: May 30, 2008

(51) Int. Cl. F01N 3/022; B23P 15/16

(52) U.S. Cl. 60/311; 423/213.2; 29/896.62; 55/523

(57) ABSTRACT

An exhaust treatment assembly is provided, which includes a plurality of first grid members. The assembly also includes a plurality of second grid members engaged with the first grid members, the grid members are arranged to form spaces. A plurality of exhaust filter elements is disposed in the spaces and forms an exhaust filter block. A first side wall is engaged with the first grid members, and is adjacent a first edge of the filter block. A second side wall is engaged with the second grid members, and is adjacent a second edge of the filter block. An insulator is located between the first side wall and the first edge of the filter block, and located between the second side wall and the second edge of the filter block.

### TECHNICAL FIELD

The present disclosure relates generally to exhaust treatment and, more particularly, to an assembly and a method of assembly for exhaust treatment.

### BACKGROUND

Internal combustion engines, including diesel engines, gasoline engines, natural gas engines, and other engines known in the art, may exhaust a complex mixture of air pollutants. The air pollutants may be composed of gaseous compounds, which may include nitrous oxides (NOx), and/or other harmful pollutants. Due to increased attention on the environment, exhaust emission standards have become more stringent, and the amount of NOx, and/or other harmful pollutants emitted to the atmosphere from an engine may be regulated depending on the type of engine, size of engine, and/or class of engine.

One method that has been implemented by engine manufacturers to comply with the regulation of these engine emissions has been to equip engines with ceramic filter elements. These ceramic filter elements may react with exhaust to reduce the amount of NOx, and/or other harmful pollutants, emitted. Such ceramic filter elements are sometimes packaged into filter assembly, sometimes referred to as a reactor unit. This may include a stainless steel box-shape structure enclosing an internal honey-comb type metal structure with the ceramic filter elements in each compartment of the honey-comb structure, and with outer walls and grids around the ceramic filter elements to provide structural integrity. These outer wall and grids are often made from stainless steel or other suitable metal.

One filter assembly is disclosed in U.S. Pat. No. 5,228,892 (the '892 patent), issued to Akitsu et al. on Jul. 20, 1993. In the '892 patent, the filter assembly may include a pair of side plates that may be integrally assembled in a square framework by the use of brackets. The '892 patent also discloses that a plurality of ceramic filter elements may be aligned in parallel within the square framework, and may be clamped by the pair of side plates. The use of the side plates, the brackets, and the square framework may require extensive consumption of stainless steel or other suitable metal, which may be expensive. Also, gaps may exist between the ceramic filter elements in the filter assembly of the '892 patent because no sealant is applied to the ceramic filter elements and their respective support structure. The existence of such gaps would, in turn, decrease the efficiency of the filter assembly.

The disclosed assembly and method of assembly for exhaust treatment are directed to improvements in the exiting technology.

### SUMMARY

In one aspect, the present disclosure is directed to an exhaust treatment assembly. The exhaust treatment assembly may include a plurality of first grid members. The exhaust treatment assembly may also include a plurality of second grid members engaged with the plurality of first grid members. The first and second grid members may be arranged to form spaces between the grid members. The exhaust treatment assembly may further include a plurality of exhaust filter elements disposed in the spaces and forming an exhaust filter block. The exhaust treatment assembly may also include a first side wall engaged with the plurality of first grid members. The first side wall may be adjacent a first edge of the exhaust filter block. The exhaust treatment assembly may further include a second side wall engaged with the plurality of second grid members. The second side wall may be adjacent a second edge of the exhaust filter block. Moreover, the exhaust treatment assembly may include an insulator located between the first side wall and the first edge of the exhaust filter block, and located between the second side wall and the second edge of the exhaust filter block.

In another aspect, the present disclosure is directed to a method of assembling an exhaust treatment assembly. The method may include providing a plurality of first grid members, each one of the first grid members having a locking member. The method may also include engaging the plurality of first grid members with a plurality of second grid members, each one of the second grid members having a locking member, and the plurality of first and second grid members forming a grid with spaces between the engaging plurality of first and second grid members. The method may further include positioning a plurality of exhaust filter elements in the spaces and forming an exhaust filter block. The method may also include wrapping a perimeter of the exhaust filter block with an insulator. The method may further include engaging a first side wall with the plurality of first grid members, the first side wall having openings configured to receive the locking members of the plurality of first grid members. Moreover, the method may include engaging a second side wall with the plurality of second grid members, the second side wall having openings configured to receive the locking members of the plurality of second grid members.

### BRIEF DESCRIPTION OF THE DRAWINGS

FIG. 1 is a top view of an exhaust treatment assembly according to an exemplary disclosed embodiment;

FIG. 2 is a top view of a grid element that may be employed in the exhaust treatment assembly of FIG. 1;

FIG. 3 is a side view of the illustrated grid element of FIG. 2;

FIG. 4 is a top view of an arrangement of exhaust filter elements that may be employed in the exhaust treatment assembly of FIG. 1;

FIG. 5 is an enlarged view of a locking mechanism that may be employed in the exhaust treatment assembly of FIG. 1;

FIG. 6 is a further enlarged view of the locking mechanism of FIG. 5;

FIG. 7 is another enlarged view of the locking mechanism of FIG. 5; and

FIG. 8 is a perspective view of the exhaust treatment assembly of FIG. 1.

### DETAILED DESCRIPTION

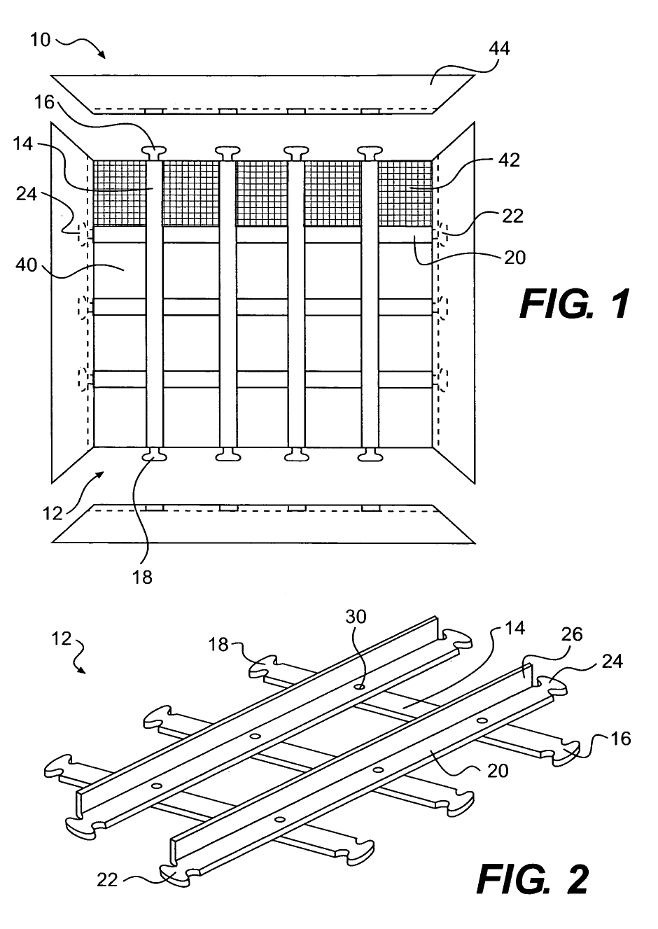

FIG. 1 illustrates an exemplary exhaust treatment assembly 10. Exhaust treatment assembly 10 may include a grid element 12, exhaust filter elements 42, and side walls 44. Grid element 12 may include first grid members 14 and second grid members 20. First grid members 14 may be elongated, generally rectangular, and planar in shape, and each first grid members 14 may include two ends 16 and 18. First grid members 14 also may be evenly spaced within grid element 12. Similarly, second grid members 20 may be elongated, generally rectangular and, planar in shape, and each second grid members 20 may include two ends 22 and 24. Second grid members 20 may also be evenly spaced within grid element 12. First grid members 14 and second grid members 20 may be formed with shapes other than planar and generally rectangular. For example, first grid members 14 and second grid members 20 may be generally cylindrical in shape. First grid members 14 and second grid members 20 may intersect to form the grid structure of grid element 12. For example, first grid members 14 and second grid members 20 may be substantially perpendicular to one another. Grid element 12 may be generally square in cross section and planar in shape, as shown in FIG. 1. However, it is contemplated that grid element 12 may assume any appropriate geometric shape suitable for use in exhaust treatment assembly 10. For example, grid element 12 may be generally circular in cross section and planar in shape, if desired.

First grid members 14 and second grid members 20 may be positioned within grid element 12 so as to form spaces 40. Spaces 40 may be, for example, generally square. Exhaust filter elements 42 may also be generally square. Exhaust filter elements 42 may be made of any appropriate type of materials employed in the art. For example, exhaust filter elements 42 may be ceramic. It is contemplated that spaces 40 may assume other geometric shapes, and similarly, exhaust filter elements 42 may assume other geometric shapes. For example, spaces 40 and exhaust filter elements 42 may be generally circular in shape. It is also contemplated that spaces 40 may assume geometric shapes that are different from the shapes of exhaust elements 42.

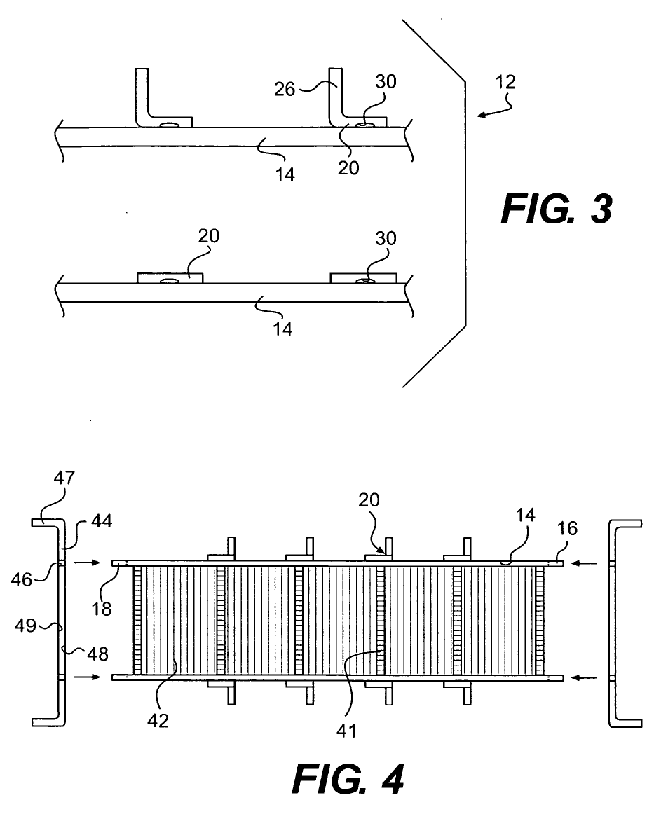

Referring to FIGS. 2 and 3, a portion of each one of first grid members 14 may overlap a portion of each one of second grid members 20. First grid members 14 may be engaged with second grid members 20 at joints 30 at the portions where the grid members overlap. The overlapping portions of first grid members 14 and second grid members 20 may be retained in engagement at joints 30 by any appropriate adhesive and/or any method capable of maintaining such engagement at joints 30. For example, first grid members 14 may be welded to second grid members 20 at joints 30. For another example, first grid members 14 may be engaged with second grid members 20 by applying industrial epoxy resin at joints 30. As illustrated in FIGS. 2 and 3, extension members 26 may extend from second grid members 20 and may be substantially perpendicular to second grid members 20. Extension members 26 may extend substantially along the entire length of second grid members 20. It is contemplated that grid element 12 may be made from any appropriate material, including but not limited to, stainless steel, other suitable metals, etc.

As illustrated in FIG. 4, exhaust filter elements 42 may be disposed within spaces 40 so that substantially the entirety of each one of exhaust filter elements 42 may be disposed within each one of spaces 40. On the other hand, exhaust filter elements 42 may be disposed within spaces 40 so that each one of exhaust filter elements 42 may be partially disposed within each one of spaces 40 and partially overlapping both first grid members 14 and second grid members 20 (not shown). Each one of exhaust filter elements 42 may be secured together to form an exhaust filter block 43 (referring to FIG. 8) by engaging one or more layers of exhaust filter elements 42. Alternatively, each one of exhaust filter elements 42 may be secured together to form a plurality of exhaust filter units. The plurality of exhaust filter units may then be secured together to form exhaust filter block 43 (referring to FIG. 8).

For example, exhaust filter block 43 may be formed by securing sixteen exhaust filter elements 42 together. On the other hand, four exhaust filter units may be formed with each exhaust filter units formed by securing four of the sixteen exhaust filter elements 42 together. The four exhaust filter units may then be secured together to form exhaust filter block 43. It is contemplated that exhaust filter block 43 may be formed by securing more or less than sixteen exhaust filter elements 42. Similarly, exhaust filter units may be formed by securing more or less than four exhaust filter elements 42.

Still referring to FIG. 4, the engagement between each one of exhaust filter elements 42 may be enhanced, for example, by applying any appropriate type of sealant between exhaust filter elements 42 at interfaces 41. An example of an appropriate type of sealant may include a high-temperature sealant. The high-temperature sealant may be a silicon-based sealant that may withstand the temperature experienced by exhaust filter elements 42 during use. The high-temperature sealant may be applied at interfaces 41 with the aid of a sealant delivery aid, such as a syringe. The high-temperature sealant may be cured at room temperature before assembling exhaust treatment assembly 10.

As shown in FIG. 4, side walls 44 may include a plurality of openings 46 and flanges 47. Flanges 47 may extend substantially perpendicular from the end portions of side walls 44 and may extend away from exhaust filter elements 42. Flanges 47 may be any appropriate type of structural members for mounting exhaust treatment assembly 10 into a machine, and/or an engine, etc. Side walls 44 may be engaged with grid element 12 by protruding ends 16 and 18 of first grid members 14 through openings 46, for example. The thickness of one side wall 44 may be defined by the distance between a first surface 48 and a second surface 49.

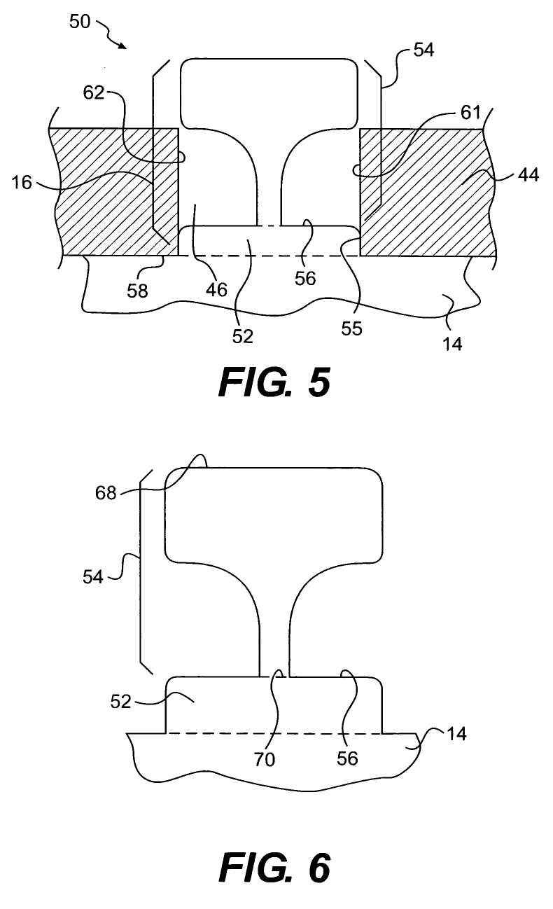

Referring to FIG. 5, by way of an example, each end 16 may include a locking mechanism 50. Similarly, each end 18, 22, and 24 may include a locking mechanism 50. Locking mechanism 50 may include a first portion and a second portion. For example, the first portion may be in the form of an alignment member 52, and the second portion may be in the form of a twist tab 54 extending from a top surface 56 of alignment member 52. The height of alignment member 52 may be defined by the distance between an edge 58 and top surface 56. The height of alignment member 52 may be less than the thickness of one side wall 44. The width of alignment member 52 may be substantially equal to the width of one opening 46, so as to engage inner surfaces 61 and 62 of opening 46. The width of one opening 46 may be defined by the distance between inner surfaces 61 and 62. It is contemplated that first grid members 14 may be permanently engaged with side walls 44. For example, one first grid member 14 and one side wall 44 may be welded together at interfaces 55, where alignment member 52 engages inner surfaces 61 and 62.

Referring to FIG. 6, twist tab 54 may include a tab fail area 70, allowing twist tab 54 to break away from alignment member 52 when necessary force is used in moving twist tab 54. Twist tab 54 may be moved from a first position to a second position. For example, in the first position, a top surface 68 of twist tab 54 and a top surface 56 of alignment member 52 may lie in a first plane in which top surface 68 may be substantially parallel to top surface 56. In the second position, top surface 68 may be substantially perpendicular to the plane in which top surface 56 lies. It is contemplated that twist tab 54 may be moved from the first position to another position where top surface 68 and top surface 56 may lie in a second plane where both top surfaces may be substantially parallel, however, the second plane may be perpendicular to the first plane where the two surfaces lie in the first position.

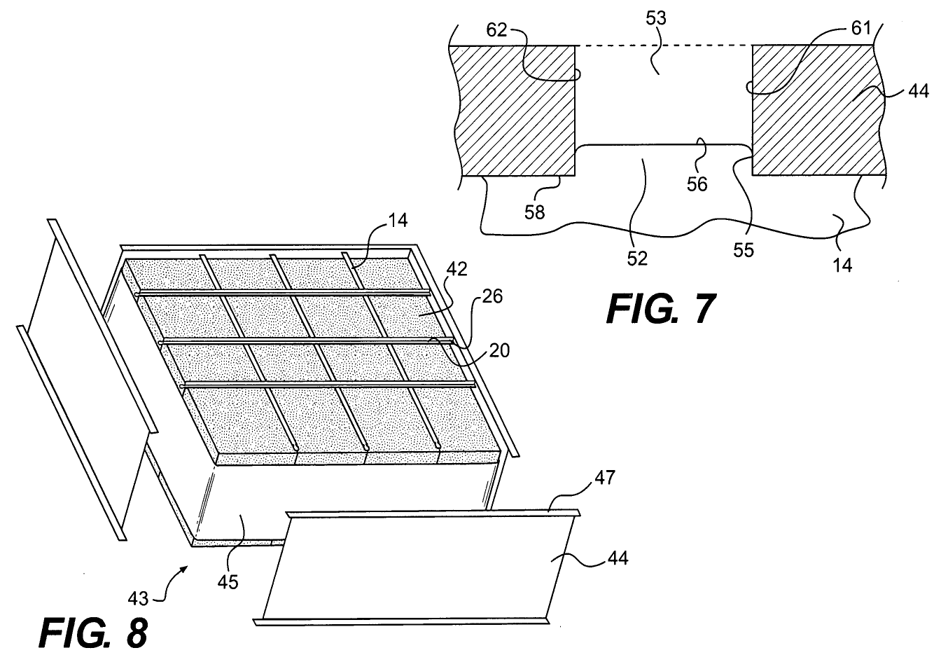

Referring to FIG. 7, twist tab 54 may be removed after alignment member 52 engages inner surfaces 61 and 62. After twist tab 54 is removed from alignment member 52, a space 53 may be formed. The width of space 53 may be defined by the distance between inner surfaces 61 and 62. The height of space 53 may be defined as the difference between the thickness of one side wall 44 and the height of alignment member 52. After removal of twist tab 54, space 53 may be filled with any appropriate material, such as a sealant or a filler. It is contemplated that the sealant used to secure the engagement between exhaust filter elements 42 may be used to fill space 53.

FIG. 8 illustrates a perspective view of exhaust treatment assembly 10. As shown in FIG. 8, when side walls 44 engage grid element 12, each one of side walls 44 may be adjacent to an edge of exhaust filter block 43. In addition, flanges 47 may extend from side walls 44 and may extend away from the exhaust filter block. The exhaust filter block may include a plurality of exhaust filter elements 42. Extension members 26 of second grid members 20 may also extend away from exhaust filter block 43. As discussed, exhaust filter block 43 may be formed by engaging exhaust filter elements 42 with one another. The engagement between each one of exhaust filter elements 42 may also be enhanced, for example, by surrounding, e.g., wrapping, exhaust filter block 43 with an insulator 45. Examples of insulator 45 may be fiberglass, any appropriate insulating and dampening material, and/or any appropriate high-temperature tolerant material that will remain stable at temperatures experienced by exhaust filter block 43 during use. In addition, any appropriate type of sealant may be applied to the interfaces (not shown) where side walls 44 engage exhaust filter block 43. It is contemplated that a second grid element (not shown) constructed similar to grid element 12 may be engaged with exhaust filter block 43, and exhaust filter block 43 may be disposed between grid element 12 and the second grid element. It is contemplated that the sealant used in exhaust treatment assembly 10 may be the same material as insulator 45.

### INDUSTRIAL APPLICABILITY

The disclosed exhaust treatment assembly may be applicable to any machine where treatment of exhaust is desired.

Exhaust treatment assembly 10 may be assembled by engaging first grid elements 14 and second grid elements 20 to form grid element 12. A plurality of exhaust filter elements 42 may then be disposed within grid element 12 and may be secured together to form exhaust filter block 43. Grid element 12 may assume any appropriate geometric shapes. For example, grid element 12 may be generally square in cross section and planar in shape. Alternatively, grid element 12 may be generally circular in cross section and planar in shape. The different geometric shapes may help to facilitate the use of grid element 12 in various applications of exhaust treatment where different geometric limitations are required. Sealant may be applied to the engagement between the plurality of exhaust filter elements 42. Exhaust filter block 43 may also be wrapped with insulator 45. Each one of the first grid members 14 and second grid members 20 may include a locking mechanism 50 at one or both ends. Locking mechanism 50 may include a first portion, such as alignment member 52, and a second portion, such as twist tab 54. Twist tab 54 may extend from top surface 56 of alignment member 52. Side walls 44 may engage grid element 12 and exhaust filter block by extending twist tab 54 through opens 46 of side walls 44. Because the width of alignment member 52 may be substantially equal to the width of one opening 46, locking mechanism 50 may facilitate assembling of exhaust treatment assembly 10 and provide more accurate positioning for the engagement of side walls 44 with first and second grid members 14 and 20.

The application of sealant between each one of exhaust filter elements 42 to form exhaust filter block 43 may help to reduce the possibility of a gap existing within exhaust filter block 43. The surrounding of exhaust filter block 43 with insulator 45 may also help to reduce the likelihood of a gap existing within exhaust filter block 43. The application of sealant and the surrounding of exhaust filter block 43 with insulator 45 may also help to enhance the structural integrity of exhaust filter block 43. The existence of gap within exhaust filter block 43 may allow exhaust to pass through the gap without passing through exhaust filter elements 42. Therefore, the reduction in the possibility of a gap existing within exhaust filter block 43 may improve the efficiency of exhaust filter block 43 and reduce emission.

Insulator 45 may also help to dampen vibration and impulses experienced by exhaust filter block 43 during the operation of a machine equipped with exhaust treatment assembly 10. In addition, insulator 45 may help to provide thermo-retardation of exhaust filter block 43 during the operation of a machine equipped with exhaust treatment assembly 10. The use of sealant and insulator 45 may further help to reduce the metal needed to ensure the structural integrity of exhaust filter block 43. Consequently, the cost of assembling and manufacturing exhaust treatment assembly 10 may be reduced.

Any appropriate type of sealant may be applied to the interfaces (not shown) where side walls 44 engage exhaust filter block 43. The application of sealant to the interfaces may help to reduce the likelihood of a gap existing between side walls 44 and exhaust filter block 43. The reduction of the likelihood of a gap existing within exhaust treatment assembly 10, i.e., between side walls 44 and exhaust filter block 43, may also help to improve the efficiency of exhaust treatment assembly 10 and reduce emissions.

In addition, locking mechanism 50 may help to secure the engagement of grid element 12 with side walls 44. For example, one first grid member 14 may be engaged with one side wall 44 by inserting locking mechanism 50 of one first grid member 14 through one opening 46 of one side wall 44. After one first grid member 14 engages one side wall 44, the engagement between them may be strengthened by moving twist tab 54 from a first position to a second position as described above. The engagement between alignment member 52 and inner surfaces 61 and 62 may also be strengthened by welding interfaces 55 where alignment member 52 engages inner surfaces 61 and 62. Twist tab 54 may be removed by moving twist tab 54 with necessary force. The removal of twist tab 54 may form space 53, which may be filled with any appropriate material, such as a sealant or a filler. The application of the sealant to space 53 may help to reduce the likelihood of a gap existing at interfaces 55. Flanges 47 on side walls 44 and extension members 26 on second grid members 20 may facilitate installation of exhaust treatment assembly 10 into a machine and/or an engine where an exhaust treatment assembly is desired.

It will be apparent to those skilled in the art that various modifications and variations can be made to the disclosed exhaust treatment assembly. Other embodiments will be apparent to those skilled in the art from consideration of the specification and practice of the disclosed exhaust treatment assembly. It is intended that the specification and examples be considered as exemplary only, with a true scope being indicated by the following claims.

What is claimed is:

1. An exhaust treatment assembly, comprising:
a plurality of first grid members;
a plurality of second grid members engaged with the plurality of first grid members, the first and second grid members arranged to form spaces between the grid members;
a plurality of exhaust filter elements disposed in the spaces and forming an exhaust filter block;
a first side wall engaged with the plurality of first grid members, the first side wall being adjacent a first edge of the exhaust filter block;
a second side wall engaged with the plurality of second grid members, the second side wall being adjacent a second edge of the exhaust filter block; and
an insulator located between the first side wall and the first edge of the exhaust filter block, and located between the second side wall and the second edge of the exhaust filter block.

2. The exhaust treatment assembly of claim 1, further includes:
a locking member engaged to one of the plurality of first and second grid members; and
openings disposed within the first and the second side walls, the opening configured to receive the locking members.

3. The exhaust treatment assembly of claim 1, wherein the first and second grid members are arranged to be substantially perpendicular.

4. The exhaust treatment assembly of claim 3, wherein the first and second grid members are made from metal.

5. The exhaust treatment assembly of claim 1, wherein the insulator is fiberglass.

6. The exhaust treatment assembly of claim 1, further including a sealant between the exhaust filter elements.

7. The exhaust treatment assembly of claim 1, wherein each one of the plurality of exhaust filter elements is at least partially within the spaces formed by the plurality of first grid members and the plurality of second grid members.

8. A method of assembling an exhaust treatment assembly, comprising:
providing a plurality of first grid members, each one of the first grid members having a locking member;
engaging the plurality of first grid members with a plurality of second grid members, each one of the second grid members having a locking member, and the plurality of first and second grid members forming a grid with spaces between the engaging plurality of first and second grid members;
positioning a plurality of exhaust filter elements in the spaces and forming an exhaust filter block;
wrapping a perimeter of the exhaust filter block with an insulator;
engaging a first side wall with the plurality of first grid members, the first side wall having openings configured to receive the locking members of the plurality of first grid members; and
engaging a second side wall with the plurality of second grid members, the second side wall having openings configured to receive the locking members of the plurality of second grid members.

9. The method of claim 8, further including
extending the locking members through the openings of the side walls, each locking member having a first portion and a second portion, with the first portion engaging inner surfaces of each opening and the second portion extending through each opening; and
moving the second portions relative to the first portions.

10. The method of claim 9, further including
welding the engaging first portions of the locking members with the inner surfaces of the openings; and
removing the second portions of the locking members from the first portions of the locking members.

11. The method of claim 9, further including applying a sealant to the exhaust filter elements to form the exhaust filter block.

12. The method of claim 8, wherein the grid members are made from metal.

13. The method of claim 8, wherein the insulator is fiberglass.

14. The method of claim 8, wherein the insulator is high-temperature tolerant plastic.

15. A machine, comprising:
a power source;
an exhaust system engaged with the power source; and
an exhaust treatment assembly engaged with the exhaust system to treat exhaust from the power source, the exhaust treatment assembly including:
a plurality of first grid members;
the plurality of first grid members engaged with a plurality of second grid members to form spaces;
a plurality of exhaust filter elements disposed in the spaces and forming an exhaust filter block;
at least a first side wall engaged with the plurality of first grid members, the at least a first side wall being adjacent at least a first edge of the exhaust filter block;
at least a second side wall engaged with the plurality of second grid members, the at least a second side wall being adjacent at least a second edge of the exhaust filter block; and
an insulator located between the at least a first side wall and the at least a first edge of the exhaust filter block, and located between the at least a second side wall and the at least a second edge of the exhaust filter block.

16. The machine of claim 15, wherein the plurality of first grid members are substantially perpendicular to the plurality of second grid.

17. The machine of claim 15, wherein the insulator is fiberglass.

18. The machine of claim 15, wherein each one of the plurality of exhaust filter elements is entirely within the spaces formed by the plurality of first grid members and the plurality of second grid members.

19. The machine of claim 15, wherein each one of the exhaust filter elements is partially within the spaces formed by the plurality of first grid members and the plurality of second grid members and partially overlapping the plurality of first grid members and the plurality of second grid members.

20. The machine of claim 15, further including a sealant between the exhaust filter elements.
